(19) United States
(12) Patent Application Publication
(10) Pub. No.: US 2013/0148817 A1
(43) Pub. Date: Jun. 13, 2013

(54) ABNORMALITY DETECTION APPARATUS FOR PERIODIC DRIVING SYSTEM, PROCESSING APPARATUS INCLUDING PERIODIC DRIVING SYSTEM, ABNORMALITY DETECTION METHOD FOR PERIODIC DRIVING SYSTEM, AND COMPUTER PROGRAM

(71) Applicant: TOKYO ELECTRON LIMITED, Tokyo (JP)

(72) Inventors: Tsuyoshi MORIYA, Tokyo (JP); Nobutoshi TERASAWA, Ibaraki (JP); Yuki KATAOKA, Hokkaido (JP); Masahiro YATABE, Mie (JP); Shirou ARAKI, Hiroshima (JP)

(73) Assignee: TOKYO ELECTRON LIMITED, Tokyo (JP)

(21) Appl. No.: 13/708,048

(22) Filed: Dec. 7, 2012

(30) Foreign Application Priority Data
Dec. 9, 2011 (JP) 2011-269749
Sep. 24, 2012 (JP) 2012-209497

(51) Int. Cl. H04R 29/00

(52) U.S. Cl. CPC H04R 29/00
USPC 381/56

(57) ABSTRACT

An abnormality detection apparatus for a periodic driving system includes a detection unit; a data obtaining unit for time series data from the detected sound; a determinism derivation unit configured to derive a plurality of values representing determinism providing an indicator of whether the time series data is deterministic or stochastic or a plurality of intermediate variations in a calculation process of the values representing determinism at a predetermined interval from the time series data; a probability distribution calculation unit. The abnormality detection apparatus further includes a determination unit configured to determine existence or non-existence of abnormality in the periodic driving system based on the probability distribution of the values representing determinism or the intermediate variations.

### CROSS-REFERENCE TO RELATED APPLICATION

This application claims priority to Japanese Patent Application Nos. 2011-269749 and 2012-209497 filed on Dec. 9, 2011 and Sep. 24, 2012, respectively, entire contents of which are incorporated herein by reference.

### FIELD OF THE INVENTION

The present invention relates to an abnormality detection apparatus for a periodic driving system which is used in a processing apparatus such as a semiconductor manufacturing apparatus or the like, an abnormality detection method for the periodic driving system, and a computer program.

### BACKGROUND OF THE INVENTION

Periodic driving systems which perform various periodic drives are used in a processing apparatus such as a semiconductor manufacturing apparatus or the like. Representative examples of the periodic driving systems are rotation driving systems, for example, a dipole ring magnet (DRM) in a magnetron etching apparatus for etching a semiconductor wafer, a rotation driving system of a spinner for coating resist on a semiconductor wafer, a rotation driving system for rotating a wafer boat that holds a plurality of semiconductor wafers in a batch type vertical furnace, and the like.

In the case of the above representative rotation driving systems of the periodic driving systems, grease up is required. In case of lack of grease, there occurs an error due to torque increase, and this makes the apparatus inoperable.

Therefore, it is required to detect abnormality before the apparatus becomes inoperable. In the rotation driving system, abnormality detection is performed by determining whether or not sound produced during rotation of the rotation driving system is abnormal by human ears periodically or by using iron shavings accumulated under the rotation driving system. Specifically, in the case of the abnormality detection using human ears, the sound is checked for one minute and then for additional five minutes for a suspicious apparatus.

However, the abnormality detection using human ears can be executed only by an experienced specific expert capable of determining abnormal sounds. Since the periodical detection needs to be performed for tens or hundreds of processing apparatuses in a semiconductor manufacturing factory, it is a huge burden on an operator. Further, the abnormality detection using iron shavings does not ensure high precision.

Meanwhile, a non-contact facility diagnosis method using sound detection is suggested as a method for avoiding operation failure by precisely detecting abnormality of facilities including a rotation driving system, e.g., an air conditioning fan, a pump or the like (Japanese Patent Application Publication No. H10-133740). In this technique, an abnormal signal is detected by comparing a previously measured sound pressure signal in a normal state with a sound pressure signal at the time of measurement. The signal is separated into a low frequency area corresponding to a rotation frequency and a high frequency area corresponding to a natural frequency of a member. Next, the abnormality in the fan and the pump is detected from a value obtained by removing the characteristics of the sound pressure signal in the normal state from the sound pressure signal at the time of measurement by using a filter in an autoregressive model to which a linear predicting method is applied.

Further, there is suggested a technique for detecting abnormality in a driving system by obtaining an acoustic signal from a rotation driving system as time series data, calculating a value, e.g., a translation error, that determines whether the time series data is deterministic or stochastic from the time series data, and determining whether or not the value is changed beyond a predetermined threshold value (Japanese Patent Application Publication No. 2008-14679).

However, in the technique described in Japanese Patent Application Publication No. H10-133740, a frequency of abnormal sound and a detection level need to be adjusted in accordance with characteristic differences among facilities. Moreover, if characteristic differences are not observed between spectrum distribution of normal sound and that of abnormal sound, it is difficult to detect abnormal sound.

In the technique described in Japanese Patent Application Publication No. 2008-14679, it is determined that the facilities are abnormal when the time series data obtained from the facilities in the normal state is deterministic and the value representing determinism is decreased by more than a predetermined threshold value. On the other hand, it is determined that the facilities are abnormal when the time series data obtained from the facilities in the normal state is stochastic and the value representing determinism is increased by more than the predetermined threshold value. However, if the time series data is deterministic or stochastic in both states, it is difficult to distinguish that normal state from the abnormal state.

### SUMMARY OF THE INVENTION

In view of the above, the present invention provides an abnormality detection apparatus for a periodic driving system such as a rotation driving system which is capable of detecting abnormality with precision, a processing apparatus including the periodic driving system, an abnormality detection method for the periodic driving system, and a computer program.

In accordance with a first aspect of the present invention, there is provided an abnormality detection apparatus for a periodic driving system which is used for an operation of a processing apparatus, including: a detection unit configured to detect sound from the periodic driving system; a data obtaining unit for time series data that temporally varies from the detected sound; a determinism derivation unit configured to derive a plurality of values representing determinism providing an indicator of whether the time series data is deterministic or stochastic or a plurality of intermediate variations in a calculation process of the values representing determinism at a predetermined interval from the time series data that have been obtained by the data obtaining unit; a probability distribution calculation unit configured to calculate probability distribution of the values representing determinism or the intermediate variations; and a determination unit configured to determine existence or non-existence of abnormality in the periodic driving system based on the probability distribution of the values representing determinism or the intermediate variations.

The abnormality detection apparatus may further includes: a graphic information creation unit configured to create graphic information from the probability distribution calculated by the probability distribution calculation unit, wherein the determination unit determines existence or non-existence of abnormality in the periodic driving system by comparing the graphic information generated from the probability distribution with normal sound graphic information created from the probability distribution of values representing determinism of a normal sound model or intermediate variations in the calculation process of the values thereof which have been previously obtained and/or one or more abnormal sound graphic information created from the probability distribution of values representing determinism of an abnormal sound model or intermediate variations in the calculation process of the values thereof which have been previously obtained, and then obtaining a difference rate of the graphic information from the normal sound model graphic information and/or a similarity rate of the graphic information to the abnormal sound graphic information.

Further, the graphic information, the normal sound graphic information, and the abnormal sound graphic information may be histograms created from the probability distribution of the values representing determinism.

The determination unit may calculate the difference rate from the normal sound graphic information and/or the similarity rate to the abnormal sound graphic information by comparing the histogram of the graphic information with the histogram of the normal sound graphic information and/or the histogram of the abnormal sound graphic information in aspects of four characteristic vectors including average, variance, kurtosis and skewness.

Further, the determination unit may further use, as the characteristic vectors for comparing the histogram of the graphic information with the histogram of the normal sound graphic information and/or the histogram of the abnormal sound graphic information, temporal continuity and periodic dependency of sound.

The difference rate from the normal sound graphic information and the similarity rate to the abnormal sound graphic information may be obtained by employing the characteristic vectors as initial values of training data and dividing the characteristic vectors into two classes by using a support vector machine, existence or non-existence of abnormality being determined based on whether or not a value thus obtained exceeds a predetermined threshold value.

The values representing determinism may be translation errors calculated from the time series data; and the determinism derivation unit may include: an embedding unit configured to divide the time series data into a plurality of parts at a predetermined time interval and calculating embedding vectors of arbitrary dimensions therefrom; a nearest neighboring vector extraction unit configured to extract a predetermined number of nearest neighboring vectors from a certain embedding vector among the embedding vectors calculated by the embedding unit for each of the time series data divided at the predetermined time interval; and a translation error calculation unit configured to calculate translation errors of the predetermined number of nearest neighboring vectors extracted by the nearest neighboring vector extraction unit for each of the time series data divided at the predetermined time interval.

The values representing determinism may be permutation entropies calculated from the time series data; and the determinism derivation unit may include: an embedding unit configured to dividing the time series data into multiple parts at a predetermined time interval and calculating embedding vectors of arbitrary dimensions therefrom; and a relative appearance frequency calculation unit configured to number the elements of the embedding vectors calculated from the time series data in the predetermined time in accordance with magnitude relation for each of the time series data divided at a predetermined time interval, count the number of embedding vectors having the same order as the permutation appearance frequency, and calculating the relative appearance frequency against the number of all the embedding vectors generated from the time series data in the predetermined time which is the intermediate variation in the calculation process of the permutation entropy, wherein the probability distribution calculation unit calculates probability distribution of the relative appearance frequency.

The abnormality detection apparatus may further including a display unit that displays abnormality when the abnormality is determined by the determination unit.

In accordance with a second aspect of the present invention, there is provided a processing apparatus including a processing apparatus main body for performing a predetermined processing, a periodic driving system used for processing of the processing apparatus main body, and an abnormality detection apparatus configured to detect abnormality of the periodic driving system, wherein the abnormality detection apparatus includes: a detection unit configured to detect sound from the periodic driving system; a data obtaining unit configured to obtain time series data that varies temporally from the detected sound, a determinism derivation unit configured to derive a plurality of values representing determinism providing an indicator of whether the time series data is deterministic or stochastic or a plurality of intermediate variations in a calculation process of the values representing determinism at a predetermined interval from the time series data that have been obtained by the data obtaining unit; a probability distribution calculation unit configured to calculate probability distribution of the values representing determinism or the intermediate variations; and a determination unit configured to determine existence or non-existence of abnormality in the periodic driving system based on the probability distribution of the values representing determinism or the intermediate variations.

The abnormality detection apparatus may further include an apparatus event issuing unit configured to provide warning by issuing an apparatus event to the processing apparatus body when the abnormality of the periodic driving system is determined by the determination unit.

In accordance with a third aspect of the present invention, a method for detecting abnormality of a periodic driving system used for processing of a processing apparatus, includes: obtaining time series data that varies temporally from sound detected from the periodic driving system; calculating a plurality of values representing determinism which indicates whether the time series data is deterministic or probabilistic or a plurality of intermediate variations in the calculation process of the values representing determinism at a predetermined time interval from the time series data obtained in the data obtaining step; calculating probability distribution of the values representing determinism or the intermediate variations; and determining existence or non-existence of abnormality in the periodic driving system based on the probability distribution of the values representing determinism or the intermediate variations.

The abnormality detecting method may further includes creating graphic information from the probability distribution calculated from the probability distribution calculation step, wherein in the determination step, existence or non-existence of abnormality in the periodic driving system is determined by comparing the graphic information generated from the probability distribution with normal sound graphic information created from the probability distribution of values representing determinism of a normal sound model or intermediate variations in the calculation process of the values thereof which have been previously obtained and/or one or more abnormal sound graphic information created from the probability distribution of values representing determinism of an abnormal sound model or intermediate variations in the calculation process of the values thereof which have been previously obtained, and then obtaining a difference rate of the graphic information from the normal sound model graphic information and/or a similarity rate of the graphic information to the abnormal sound graphic information.

The graphic information, the normal sound graphic information and the abnormal sound graphic information may be given as histograms created from the probability distribution of the values representing determinism. In the determination step, the difference rate from the normal sound graphic information and/or the similarity rate to the abnormal sound graphic information may be obtained by comparing the histogram of the graphic information with the histogram of the normal sound graphic information and/or the histogram of the abnormal sound graphic information in aspects of four characteristic vectors including average, variance, kurtosis and skewness.

Further, in the determination step, temporal continuity and periodic dependency of sound may be further used as the characteristic vectors for comparing the histogram of the graphic information with the histogram of the normal sound graphic information and/or the histogram of the abnormal sound graphic information.

The difference rate from the normal sound graphic information and the similarity rate to the abnormal sound graphic information may be obtained by employing the characteristic vectors as initial values of training data and dividing the characteristic vectors into two classes by using a support vector machine, existence or non-existence of abnormality being determined based on whether or not a value thus obtained exceeds a predetermined threshold value.

The values representing determinism may be translation errors calculated from the time series data; and the determinism derivation step includes: dividing the time series data into a plurality of parts at a predetermined time interval and calculating embedding vectors of arbitrary dimensions therefrom; extracting respectively predetermined numbers of nearest neighboring vectors from a certain embedding vector among the embedding vectors calculated by the embedding unit for each of the time series data divided at the predetermined time interval; and calculating translation errors of the predetermined number of nearest neighboring vectors extracted by the nearest neighboring vector extraction unit for each of the time series data divided at the predetermined time interval.

The values representing determinism may be permutation entropies calculated from the time series data; the determinism derivation step includes: dividing the time series data into multiple parts at a predetermined time interval and calculating embedding vectors of arbitrary dimensions therefrom; and numbering the elements of the embedding vectors calculated from the time series data in the predetermined time in accordance with magnitude relation for each of the time series data divided at a predetermined time interval, counting the number of embedding vectors having the same order as the permutation appearance frequency, and calculating the relative appearance frequency against the number of all the embedding vectors generated from the time series data in the predetermined time which is the intermediate variation in the calculation process of the permutation entropy, wherein in the probability distribution calculation step, the probability distribution of the relative appearance frequency is calculated.

The abnormality detecting method may further include displaying abnormality when the abnormality is determined by the determination unit.

In accordance with a fourth aspect of the present invention, there is provided a computer program for causing a computer to perform the following steps in order to detect abnormality of a periodic driving system used for processing of a processing apparatus: obtaining time series data that temporally varies from sound detected from the periodic driving system; deriving a plurality of values representing determinism providing an indicator of whether the time series data is deterministic or stochastic or a plurality of intermediate variations in a calculation process of the values representing determinism at a predetermined interval from the time series data that have been obtained by the data obtaining unit; calculating probability distribution of the values representing determinism or the intermediate variations; and determining existence or non-existence in abnormality of the periodic driving system based on the probability distribution of the values representing determinism or the intermediate variations.

In the present invention, examples of the periodic driving system include a rotation driving system, a linear driving system, a vibration system, and a compression and expansion driving system.

In accordance with the present invention, the time series data is obtained by detecting sound from the periodic driving system such as the rotation driving system. Then, the values representing determinism which are indicators of whether the time series data is deterministic or stochastic or the intermediate variations in the calculation process of such values are calculated from the time series data at a predetermined interval. Next, the probability distribution is obtained from the values representing determinism or the intermediate variations in the calculation process of such values, and the abnormality of the periodic driving system is determined based on the probability distribution. Therefore, even a small difference between a value representing determinism in an abnormal state and that in a normal state can be recognized as a large difference. Accordingly, the difference between the abnormal state and the normal state can be recognized regardless of whether the value representing determinism is deterministic or stochastic. As a result, the abnormality of the periodic driving system can be detected with high precision.

### BRIEF DESCRIPTION OF THE DRAWINGS

The objects and features of the present invention will become apparent from the following description of embodiments, given in conjunction with the accompanying drawings, in which:

FIG. 1 shows a schematic configuration of an abnormality detection apparatus for a rotation driving system as a periodic driving system in accordance with a first embodiment of the present invention;

FIG. 2 is a block diagram showing the abnormality detection apparatus for the rotation driving system in accordance with the first embodiment;

FIG. 3 is a flowchart showing an example of an operation of detecting abnormality of the rotation driving system in accordance with the first embodiment;

FIG. 4 shows an example of time series data of normal sound and an example of time series data of abnormal sound;

FIG. 5 is a graph showing a relationship between an embedding dimension on a horizontal axis and a translation error on a vertical axis in a normal state and an abnormal state;

FIG. 6 shows a probability distribution of a translation error;

FIG. 7 shows an example of a histogram created from a probability distribution p1(x1(t)) of a translation error in a normal state (normal sound);

FIG. 8 shows an example of a histogram created from a probability distribution p2(x2(t)) of a translation error in an abnormal state (abnormal sound);

FIG. 9 shows four characteristic vectors (average, variance, kurtosis and skewness) of the histogram of the normal sound in FIG. 7 and the histogram of the abnormal sound in FIG. 8;

FIG. 10 shows a rotation angle of about 150 ms as a calculation unit of a translation error;

FIG. 11 visualizes determination based on a rotation cycle by dividing the calculation result of the translation error in the unit of about 3 sec (one cycle) in the histogram of the normal sound of FIG. 7 and the histogram of the abnormal sound of FIG. 8, wherein FIG. 11A corresponds to the normal sound and FIG. 11B to the abnormal sound;

FIG. 12 shows a state in which abnormal sound is detected at a position of about 180° to 216°;

FIG. 13 visualizes determination based on a rotation cycle in FIG. 12;

FIG. 14 shows an example of abnormality detection in the case of applying a Western Electric (WE) Rule;

FIG. 15 shows an example of a processing apparatus including the abnormality detection apparatus in accordance with the first embodiment;

FIG. 16 is a block diagram showing an abnormality detection apparatus for a rotation driving system as a periodic driving system in accordance with a second embodiment of the present invention; and

FIG. 17 is a flowchart showing an example of an operation of detecting abnormality of the rotation driving system in accordance with the second embodiment.

### DETAILED DESCRIPTION OF THE EMBODIMENTS

Hereinafter, embodiments of the present invention will be described with reference to the accompanying drawings. In the present embodiments, a rotation driving system as an example of a periodic driving system will be described.

### First Embodiment

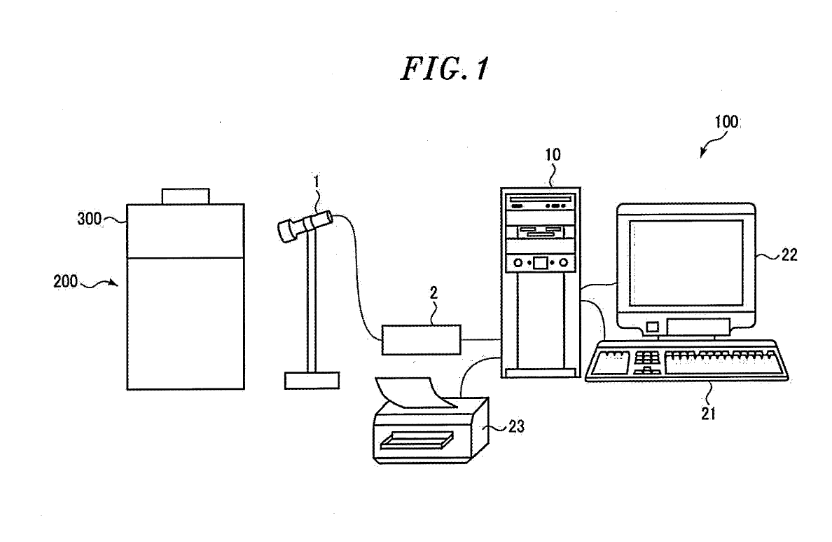

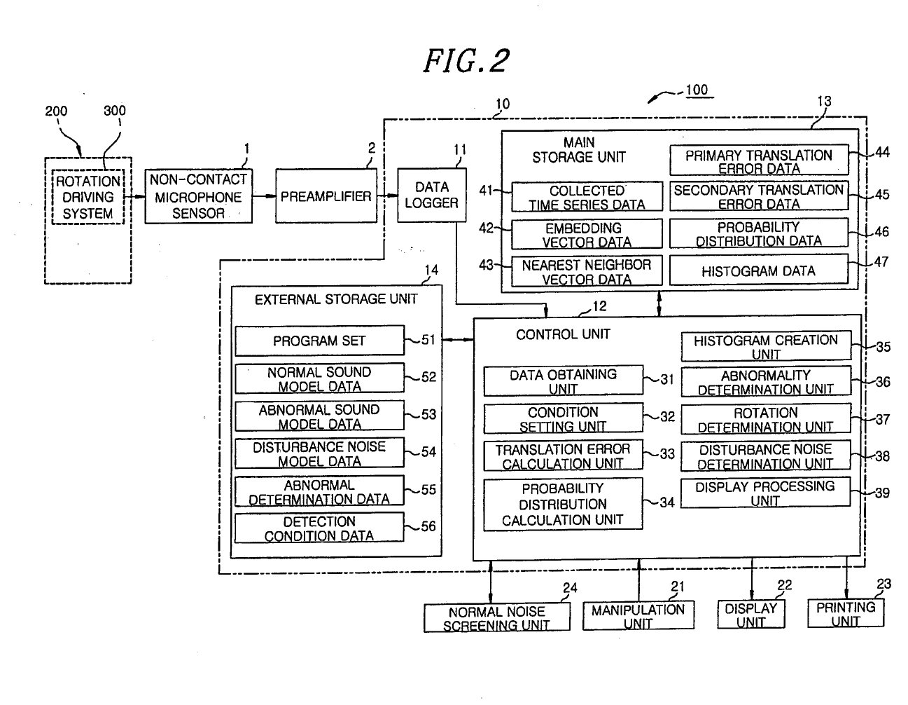

FIG. 1 shows a schematic configuration of an abnormality detection apparatus for a rotation driving system as a periodic driving system in accordance with a first embodiment of the present invention and FIG. 2 is a block diagram thereof.

An abnormality detection apparatus 100 for a rotation driving system 300 detects abnormality of a rotation driving system 300 used for an operation of a processing apparatus 200 based on sound of the rotation driving system 300. The abnormality detection apparatus 100 for a rotation driving system includes: a non-contact microphone sensor 1 (detection unit) for detecting sound of the rotation driving system 300 as a sound pressure signal; a preamplifier 2 for amplifying the detected sound pressure signal; and a detection unit 10 for detecting abnormality of the rotation driving system 300 based on the sound pressure signal amplified by the preamplifier 2 and outputting the result thereof. The detection unit 10 is connected to a manipulation unit 21 (keyboard, mouse or the like), a display unit 22 (display) and a printing unit 23 (printer). As an example of the processing apparatus 200, a magnetron etching apparatus is described. As an example of the rotation driving system 300, a dipole ring magnet (DRM) is described.

The detection unit 10 is formed of, e.g., a personal computer (PC), and includes a data logger 11, a control unit 12, a main storage unit 13, and an external storage unit 14.

The data logger 11 converts the sound pressure signal amplified by the preamplifier 2 into a digital signal and generates time series data.

The control unit 12 has a CPU (Central Processing Unit). The control unit 12 determines whether or not the rotation driving system 300 is abnormal by performing the time series signal processing on the time series data from the data logger 11 and outputs the determination result.

The main storage unit 13 is formed of, e.g., a RAM, and used for an operation area of the control unit 12. The main storage unit 13 stores collected time series data 41 collected from the data logger 11 and data that may be obtained during the time series signal processing, i.e., embedding vector data 42, nearest neighboring vector data 43, primary translation error data 44, secondary translation error data 45, translation error probability distribution data 46, histogram data 47 and the like.

The external storage unit 14 is formed of a non-volatile memory such as a hard disk, a flash memory, a CD-ROM or the like, and stores in advance a program set 51 for allowing the control unit 12 to perform a predetermined signal processing. Further, the external storage unit 14 stores normal sound model data 52, one or more abnormal sound model data 53, one or more disturbance noise model data 54, abnormal sound determination data 55 supplied from the control unit 12, detection condition data 56 and the like.

The manipulation unit 21 (keyboard, mouse or the like), the display unit 22 (display), and the printing unit 23 (printer) are connected to the control unit 12 of the detection unit 10. An operator sends an instruction to the control unit 12 by using the manipulation unit 21. The display unit 22 displays data required for the processing of the control unit 12. The printing unit 23 prints the determination result outputted from the control unit 12 or the data required for the processing of the control unit 12. Further, the control unit 12 is connected to a stationary noise screening unit 24 for screening a stationary noise.

Next, the signal processing of the control unit 12 will be described.

The control unit 12 converts the time series signal data that has been converted into the digital data by the data logger 11 into a cyclic signal by performing time series signal processing. Moreover, a translation error is calculated, as a value representing determinism which indicates whether the time series data is deterministic or stochastic, at a predetermined interval from the time series data converted into the cyclic signal. Then, a histogram graphically illustrating a translation error probability distribution is created. By comparing this histogram with the normal sound model (histogram) and one or more abnormal sound models (histograms), it is determined whether or not the rotation driving system is abnormal.

The translation error of the time series data is described in the time series analysis algorithm proposed by Wayland et al. (R. Wayland, D. Bromley, D. Pickett and A. Passamante, Physical. Review Letters, Vol. pp. 580-582 (1993)). By employing the time series analysis algorithm of Wayland et al., it can be quantitatively assessed on how many deterministic aspects are recognized in complex variances.

In other words, when time series data, i.e., {r(ti)} (i=0, . . . , N−1) is applied, an embedding vector, i.e., r(ti)={r(ti), r(ti−Δt), . . . , r(ti−(n−1)Δt}^{T}, is generated at a time of ti. Here, the superscript^{T} denotes a transposed matrix; n denotes an embedding dimension; and Δt denotes, e.g., an appropriate time difference selected from mutual information.

K nearest neighboring vectors of a certain embedding vector r(t0) are extracted from an embedding vector set. The distances between the vectors are represented as the Euclidian distance. When the K nearest neighboring vectors are represented as r(tj) (j=1, . . . , K), vectors after the time lapse of TΔt for each of r(tj) are to be r(tj+TΔt). At this time, the track change of the embedding vector after the time lapse is approximately represented by:

v(tj)=r(tj+TΔt)−r(tj): (1)

If the time evolution is deterministic, the part that is proximal to each track group of the neighboring vectors will be shifted to the part that is proximal after TΔt has passed. Thus, the dispersion in the direction of the difference vector v (tj) will be a quantitative indicator of assessing how deterministic the observed time evolution is recognized. The dispersion in the direction of v (tj) is referred to as a translation error (Etrans) and represented by the following formula:

$$\begin{matrix}{E}_{trans} = \frac{1}{K + 1} {\sum }_{j = 0}^{K} \frac{‖ v ( tj ) - \overline{v} ‖}{‖ \overline{v} ‖} & ( 2 ) \\ \overline{v} = \frac{1}{K + 1} {\sum }_{j = 0}^{K} v ( tj ) & ( 3 )\end{matrix}$$

In order to suppress Etrans error caused by the selection of r(t₀), the operation that calculates the median value for M randomly selected r(t₀)s is repeated Q times, and Etrans is assessed by the mean of the Q medians. As the deterministic aspect of the time series data increases, Etrans will approach 0. If the time series data is a white noise, Etrans used as the median will be proximal to 1, because the difference vector v (tj) is homogeneously and isotropically distributed. If the time series data is a stochastic process having a strong linear correlation, Etrans will become smaller than 1, because the direction of the neighboring track group becomes more or less aligned as a result of autocorrelation. In that case, the numerical method shows Etrans>0.5. In the range of 0.1<Etrans<0.5, the time series data may be stochastic time series, or deterministic time series that is contaminated by an observed noise. In the case of Etrans<0.1, it is not possible to explain that the time series data is the stochastic process, and it is fully recognized that it is deterministic. Therefore, the translation error can be used as a value representing the determinism.

In the present embodiment, in order to perform such functions, the control unit 12 has a data obtaining unit 31 for obtaining the time series data from the data logger 11, a condition setting unit 32 for setting conditions for abnormality detection, a translation error calculation unit 33 for calculating a translation error Etrans from the time series data obtained by the data obtaining unit 31, a probability distribution calculation unit 34 for calculating probability distribution of the translation error Etrans, a histogram creation unit 35 for creating a histogram of the probability distribution, and an abnormality determination unit 36 for determining whether or not the rotation driving system is abnormal by comparing the created histogram with the normal sound model histogram and the abnormal sound model histogram. In addition, the control unit 12 has a rotation determination unit 37 for determining whether or not the rotation driving system is rotating, a disturbance noise determination unit 38 for determining whether or not disturbance noise exists, and a display processing unit 39.

The data obtaining unit 31 collects time series data from the data logger 11 and stores the time series data as the collected time series data 41 in the main storage unit 13. The time series data is obtained by sampling sound of a predetermined frequency in a predetermined sampling cycle for a predetermined period of time.

The condition setting unit 32 sets conditions for abnormality detection, such as a sampling cycle or sampling time for the time series data. The condition setting unit 32 sets conditions by retrieving appropriate conditions from the detection condition data 56 stored in the external storage unit 14.

The translation error calculation unit 33 generates embedding vectors, extracts nearest neighboring vectors, calculates translation errors, and calculates medians of the translation errors and a mean of the medians.

As described above, the embedding vectors are generated from the collected time series data 41. An embedding dimension n and a time difference Δt are preset in accordance with the characteristics of the time series data. Further, a set of the generated embedding vectors is stored as the embedding vector data 42 in the main storage unit 13.

A certain embedding vector r(t0) is selected from the embedding vector data 42, and K embedding vectors that are nearest to the embedding vector r(t0) selected from the embedding vector set, i.e., the nearest neighboring vectors, r(tj) (j=1, . . . , K), are extracted. Respective nearest neighboring vectors that are nearest to randomly selected MM embedding vectors are extracted and stored as the nearest neighboring vector data 43 in the main storage unit 13. The number K of the nearest-neighboring vectors and the number M of the selection are preset in accordance with the characteristics of the time series data in order to suppress the statistical error in the translation error calculation. Further, the random selection of the M embedding vectors and the extraction of the respective nearest-neighboring vectors are repeated Q times.

The translation errors Etrans that is the dispersion of the directions of the nearest-neighboring vector set are calculated. At this time, the translation errors Etrans for the respective nearest-neighboring vectors of the M randomly selected embedding vectors are calculated. Moreover, the translation errors Etrans for the respective nearest-neighboring vector set of the M embedding vectors are calculated and stored as primary translation error data 44 in the main storage unit 13, which is repeated Q times for respective selections of the M embedding vectors. The medians of the M translation errors for each time are obtained from the primary translation error data 44, and the mean of the Q medians is calculated and stored as a secondary translation error data 45 in the main storage unit 13. The secondary translation error data 45 is used as translation error in order to calculate probability distribution. The translation error as the mean is obtained at a predetermined time interval of, e.g., about 150 ms.

The probability distribution calculation unit 34 calculates probability distribution of the translation error from the secondary translation error data obtained at an interval of about 150 ms. The probability distribution of the translation error is represented by p(x(t)) by using a stochastic process x(t) of the translation error at time t. The calculated probability distribution of the translation errors is stored as translation error probability distribution data 46 in the main storage unit 13. When the probability distribution is calculated, the detection time is divided into predetermined intervals and the translation errors in the given time are calculated. For example, the time series data of about five minutes is divided in the unit of one minute, and one minute is defined as specified time for calculating probability distribution. The probability distribution of translation errors calculated at every 150 ms is obtained within one minute.

The histogram creation unit 35 creates a histogram expressing respective frequencies of translation errors as graphical information based on the probability distribution data. The created histogram is stored as the histogram data 47 in the main storage unit 13.

The abnormality determination unit 36 determines whether or not the rotation driving system is abnormal by comparing the created histogram data with the normal sound model data 52 and one or more abnormal sound model data 53 which have been previously stored in the external storage unit 14.

Specifically, the normal sound model data 52 of the external storage unit 14 is a histogram data created from the probability distribution of the translation errors by performing the aforementioned signal processing of the time series data of the normal sound model. The abnormal sound model data 53 is a histogram data created from the probability distribution of the translation errors by performing the aforementioned signal processing of the time series data of one or more abnormal sound models. By comparing the histogram of the data to be detected with the histogram of the normal sound model, a difference rate from the normal sound model is calculated. Further, by comparing the histogram of the data to be detected with the histogram of one or more abnormal sound models, a similarity rate to the abnormal sound model is calculated. Accordingly, the existence or non-existence of abnormality is determined.

The rotation determination unit 37 determines whether or not the time series signal exceeds a predetermined sound pressure level. When the time series signal exceeds the predetermined sound pressure level, it is determined that the rotation driving system is rotating and the abnormality detection sequence is carried out.

The disturbance noise determination unit 38 determines the existence or non-existence of disturbance noise by comparing the histogram of the probability distribution obtained from the translation errors of the time series data with one or more disturbance noise model data 54 stored in the external storage unit 14.

The disturbance noise model data 54 of the external storage unit 14 is a histogram data created from the probability distribution of the translation errors by performing the aforementioned signal processing of the time series data of the disturbance noise. By comparing the histogram of the data to be detected with the disturbance noise model, the similarity to the disturbance noise model is checked. If the similarity is detected, it is determined that the disturbance noise exists, and the abnormality determination unit 36 does not perform abnormality determination.

The display processing unit 39 displays on the display 22 the changes in the means of the translation errors, the probability distribution of the translation errors, the histograms, and the abnormality detection result. The display processing unit 39 allows the printing unit 23 to print such information. When the abnormality is detected, alarm such as flickering light or the like may be displayed. Moreover, alarming sound such as buzzer or the like may be provided in addition to the above alarm display.

Hereinafter, an abnormality detection operation in the abnormality detection apparatus for a rotation driving system in accordance with the first embodiment which has the above configuration will be described. Further, the following operations are performed based on instructions from the control unit 12.

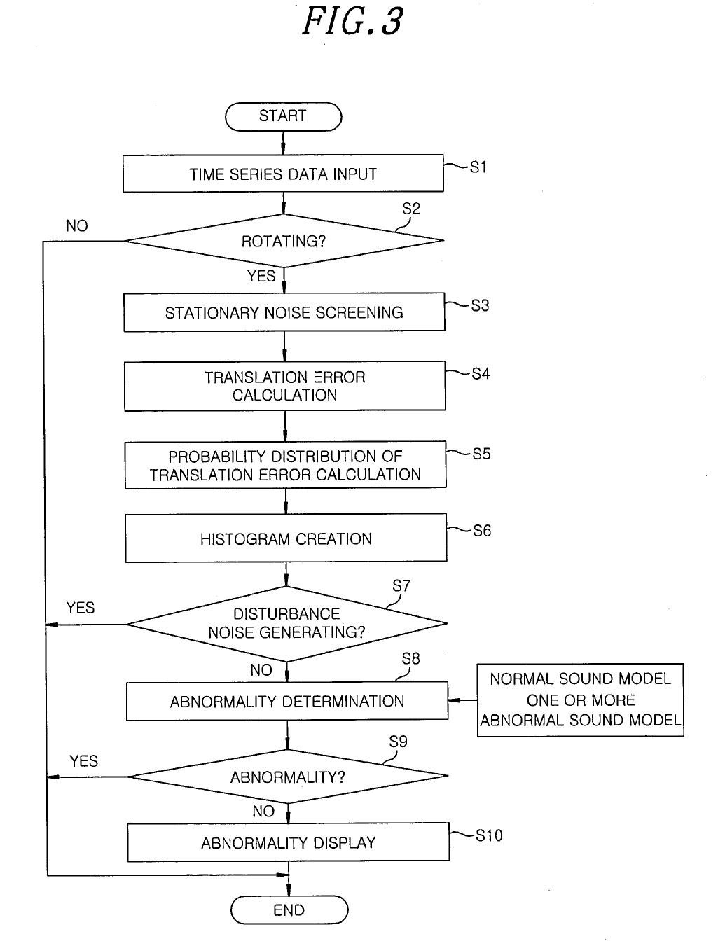

FIG. 3 is a flowchart showing an example of an abnormality detection operation for a rotation driving system in the first embodiment. First, sound of a rotation driving system to be detected, e.g., the rotation driving system 300 of a dipole ring magnet (DRM), is detected as a sound pressure signal by the non-contact microphone sensor 1, and amplified by the pre-amplifier 2, and then inputted as time series data by the data logger 11 of the detection unit (step S1). Specifically, the sound pressure signal amplified by the pre-amplifier 2 is digitally converted to the time series data by the data logger 11, and collected by the data obtaining unit 31, and then stored as the collected time series data 41 in the main storage unit 13. The time series data is obtained by sampling sound of a predetermined frequency in a predetermined sampling cycle for a predetermined period of time. The following is specific example of measurement conditions.
sensor frequency band: 20 Hz to 10 kHz
sampling period (frequency): 100 μs (10 kHz)
specified time for abnormality detection: 5 min
acceleration resolution: ±1.00 m/s² or above

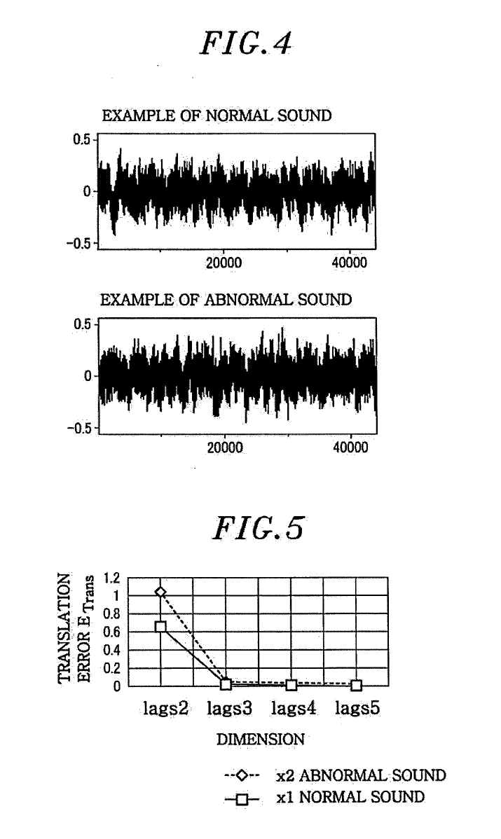

Although the examples of the time series data of the normal sound and those of the abnormal sound are illustrated in FIG. 4, it is difficult to detect accurate difference therebetween from the continuous real-time wave form.

Next, whether or not the rotation driving system 300 is rotating is determined by the rotation determination unit 37 (step S2). Specifically, it is determined whether or not the time series signal exceeds a predetermined sound pressure level. If the time series signal exceeds the predetermined sound pressure level, it is determined that the rotation driving system is rotating and a post abnormality detection sequence is performed. On the other hand, if it is determined that the rotation driving system is not rotating, the sequence is completed. Here, in view of preventing detection errors, it is preferable to perform simple signal processing. For example, it is determined that the rotation driving system is rotating in the case where mean and variance are within respective specified ranges after an envelope filter is applied to the time series data of specified time.

After the rotation of the rotation driving system is detected, the stationary noise screening unit 24 performs screening of stationary noise having a strong standing waveform caused by environment (step S3). This is because considerable decrease of an S/N ratio in a frequency band where the stationary noise exists needs to be prevented. The stationary noise is screened by using a band pass filter. During the screening, the sound is detected in a state where the rotation driving system is stopped in order to avoid the disturbance noise. Then, the frequency components of the obtained time series data are analyzed, and the screening is performed by the stationary noise screening unit 24 based on the analyzed frequency components.

Thereafter, the translation errors are calculated from the time series data (step S4). Here, the translation error calculation unit 33 generates embedding vectors, extracts nearest neighboring vectors, calculates translation errors, and calculates medians of the translation errors and obtains a mean thereof.

Specifically, first, embedding vectors r(ti) are generated from the collected time series data 41 by using the embedding dimension n and the time difference Δt which have been preset in accordance with the characteristics thereof. Thereafter, the M embedding vectors are selected randomly from the set of the embedding vectors, and respective nearest neighboring vectors nearest to the M embedding vectors are extracted. Next, the random selection of the M embedding vectors and the extraction of respective nearest-neighboring vectors thereto are repeated Q times, thereby calculating the translation error Etrans that is dispersion from the nearest-neighboring vectors in the direction thereof. The translation error Etrans is referred to as the primary translation error data 44. Then, the M medians of the translation errors are calculated from the primary translation error data 44, and this process is repeated Q times to calculate the mean of the medians. Such values are referred to as the secondary translation error data 45. The secondary translation error data 45 are used as the translation errors for calculating probability distribution.

FIG. 5 shows examples of translation errors in a normal state and an abnormal state in the case where the time difference Δt is about 6 ms. FIG. 5 shows relationship between an embedding dimension on a horizontal axis and a translation error on a vertical axis in the normal state and the abnormal state. In FIG. 5, x1 and x2 indicate the translation errors in the normal state and the translation error in the abnormal state, respectively. When the embedding dimension is about 3 or above, a significant difference is not observed between both translation errors.

Next, the probability distribution calculation unit 34 calculates probability distribution by using a plurality of secondary translation error data obtained by the translation error calculation that has been performed for a predetermined period of time (step S5). The probability distribution is calculated by dividing the time series data of five minutes in the unit of one minute and calculating translation errors within one minute.

FIG. 6 shows probability distribution p(x(t)) for x(t). FIG. 6 illustrates an example of the normal state. Further, the number of samples used for the probability distribution calculation is preferably determined based on evaluation of stationary or ergodic properties.

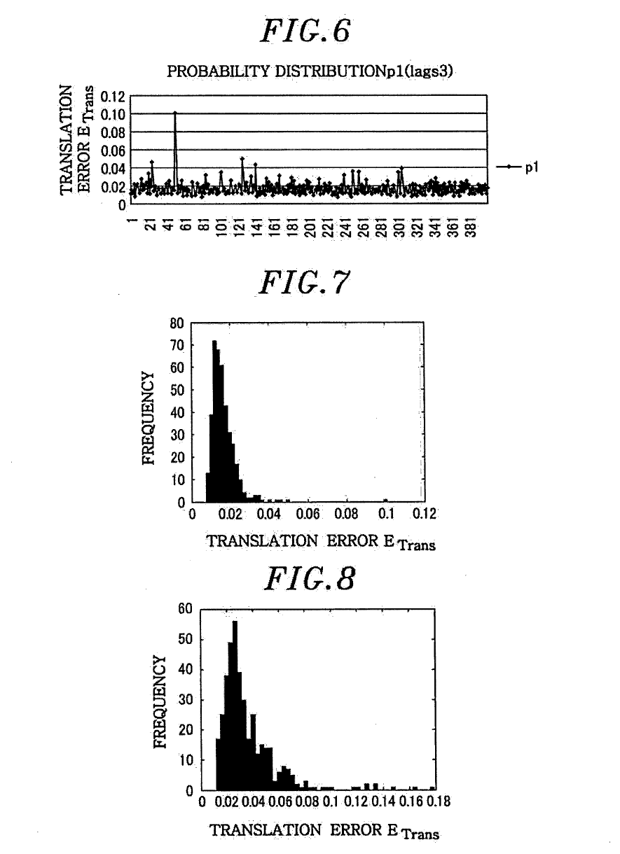

Next, the histogram creation unit 35 creates a histogram representing frequencies of translation errors based on the probability distribution data (step S6). FIG. 7 shows an example of a histogram created from probability distribution p1(x1(t)) of translation errors in the normal state (normal sound). FIG. 8 shows an example of a histogram created from probability distribution p2(x2(t)) of translation errors in the abnormal condition (abnormal sound). As shown in FIGS. 7 and 8, a significant difference is observed therebetween.

Then, the disturbance noise determination unit 38 determines existence or non-existence of disturbance noise by comparing the created histogram with the histogram of the disturbance noise model and one or more disturbance noise model data 54 (step S7).

In a field where a processing apparatus such as a semiconductor manufacturing apparatus or the like is provided, various operational sounds of the apparatus are produced and these disturbance factors may cause detection errors. Hence, when the operational sounds that may cause detection errors continue for a predetermined period of time (e.g., about 1 min), the existence or non-existence of the disturbance noise is determined by comparing them with a disturbance noise model that has been created in advance.

The disturbance noise modeling is performed in the following sequences.

(a) A disturbance noise as a modeling target is detected for specified time for abnormality detection. If the measurement cannot be continued more than one minute, the time series data may be assembled after the divided detection.

(b) A characteristic frequency of the detected noise is extracted.

(c) If the frequency of the noise does not satisfy the analysis conditions, the detected noise is considered as stationary noise.

(d) If the frequency of the noise satisfies the analysis conditions, it is registered as the analysis conditions of the disturbance noise. Next, a histogram is created from the probability distribution of translation errors by performing the aforementioned signal processing of the time series signal data to be detected. The created histogram is stored as the disturbance noise model 54 in the external storage unit 14. When two or more disturbance noises exist, the disturbance noise models are generated as many as the number of the disturbance noises.

The existence or non-existence of the disturbance noise is determined by detecting similarity between the histogram of the data to be detected and the histogram of one or more disturbance noise model data 54. If the similarity is detected, it is determined that the disturbance noise exists and the sequence is completed. The sequence proceeds only when the similarity is not detected.

When it is determined the disturbance noise is not generated, the abnormality determination unit 36 determines whether or not the detection target is abnormal (step S8).

The abnormality determination is executed by comparing the histogram data created from the translation errors of the time series data to be detected with the normal sound model data 52 and one or more abnormal sound model data 53 which have been previously stored in the external storage unit 14.

The normal sound model data 52 is a histogram data created from the probability distribution of translation errors by performing the aforementioned signal processing on the time series data of the normal sound model. The abnormal sound model data 53 is a histogram data created from the probability distribution of translation errors by performing the aforementioned signal processing on the time series data of one or more abnormal sound models. By comparing the histogram of the data to be detected with the histogram of the normal sound model, a difference rate from the normal sound model is calculated. Further, by comparing the histogram of the data to be detected with the histogram of one or more abnormal sound models, a similarity rate to the abnormal sound model is calculated. Accordingly, the existence or non-existence of abnormality is determined.

Although there may be provided a single abnormal sound model, it is preferable to use a plurality of abnormal sound models from a plurality of abnormal sound samples because different abnormal sounds are generated depending on types of friction at a driving portion.

The disturbance noise modeling is performed in the following sequences.

(a) Abnormal sound as a modeling target is detected for specified time for abnormality detection.

(b) The stationary noise is screened.

(c) A characteristic frequency is extracted from the detected abnormal noise. When a plurality of abnormal sound samples is provided, a common frequency thereof is extracted.

(d) A sampling cycle of the Wayland test is calculated from the frequency obtained in (c) and used as analysis conditions of the abnormal sound. A histogram is created from the probability distribution of the translation errors by performing the aforementioned signal processing on the time series data to be detected, and then is stored as the abnormal sound model data 53 in the external storage unit 14. When two or more abnormal sounds exist, the abnormal sound models are created as many as the number of abnormal sounds.

The difference rate from the translation errors which is obtained from the time series data of the normal sound is used for abnormality determination. However, a rotational resonance frequency of the rotation driving system may be used for the abnormality determination conditions.

The stationary noise modeling is performed in the following sequences.

(a) The normal sound is detected for specified time for abnormality determination and used as a normal sound sample.

(b) The normal sound is screened.

(c) A characteristic frequency of the normal noise sample is extracted.

(d) A sampling cycle of the Wayland test is calculated from the frequency obtained in (c) and used as analysis conditions of the normal sound. A histogram is created from the probability distribution of the translation errors by performing the aforementioned signal processing on the time series data to be detected, and then is stored as the normal sound model data 53 in the external storage unit 14.

In order to obtain a difference rate from the normal sound and a similarity rate to the abnormal sound, four characteristic vectors (average, variance, kurtosis and skewness) of the histogram created in the step S6 are compared with those of the normal sound model (histogram) and the abnormal sound model (histogram).

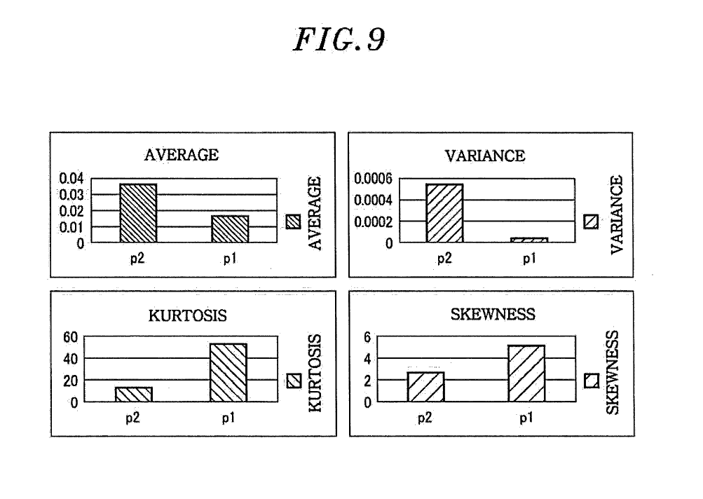

FIG. 9 shows the four characteristic vectors of the histogram of the normal sound in FIG. 7 and the histogram of the abnormal sound in FIG. 8. In FIG. 9, a significant difference is observed between the four characteristic vectors of the normal sound and those of the abnormal sound.

When a specific part of a bearing has a trouble such as partial abrasion of the bearing or infiltration of impurities into a driving gear, abnormal sounds may occur at a regular interval depending on a rotation cycle of the rotation driving system. However, it may be detected by obtaining temporal continuity and rotation cycle dependency (angle) of sound as the characteristic vectors from the histogram data of the translation errors. Thus, the temporal continuity and the rotation cycle dependency (angle) may be added to the characteristics vectors.

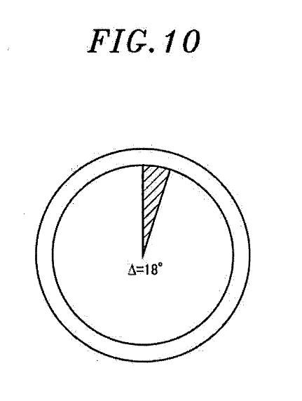

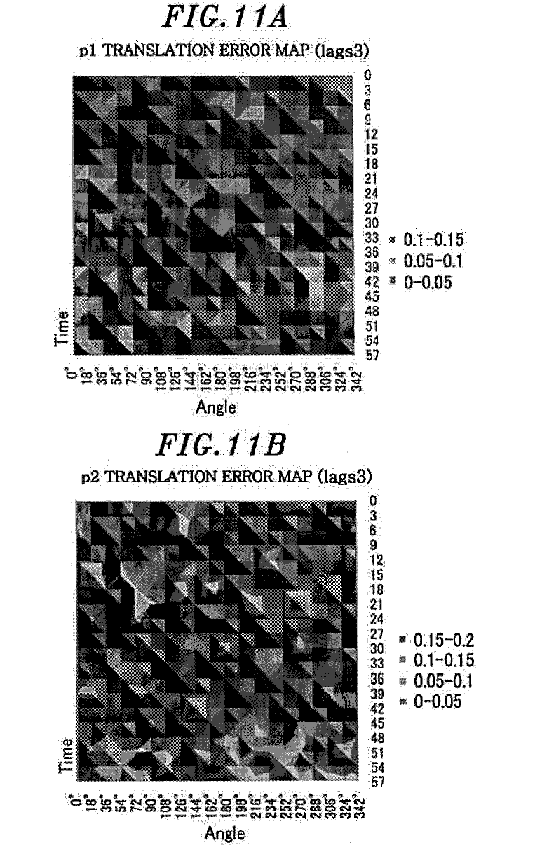

On the assumption that a rotation driving system, e.g., a DRM, rotates at a speed of about 20 rpm, a rotation cycle becomes about three seconds. The calculation unit of the translation error which is about 150 ms corresponds to a rotation angle of about 18°, as shown in FIG. 10. FIG. 11 visualizes determination of the rotation cycle dependency by dividing the calculation result of the translation errors in the unit of about 3 sec (one cycle) in the histogram of the normal sound of FIG. 7 and the histogram of the abnormal sound of FIG. 8, wherein FIG. 11A corresponds to the normal sound and FIG. 11B corresponds to the abnormal sound. A horizontal axis represents an angle, and a vertical axis represents detection time. The relation in the translation errors is indicated by a brightness relation. The brightness difference on the horizontal axis denotes temporal continuity of sound, and the brightness difference on the vertical axis denotes reproducibility at a specific angle of sound. As shown in FIGS. 11A and 11B, a mosaic pattern of small variance and similar brightness is observed in the normal sound p1, and a time zone in which the translation errors are drastically changed is observed in the abnormal sound p2.

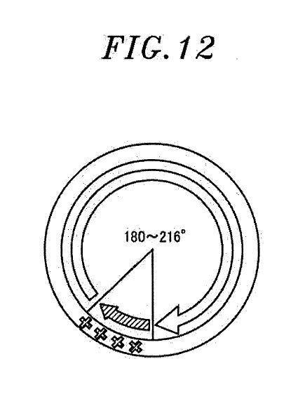

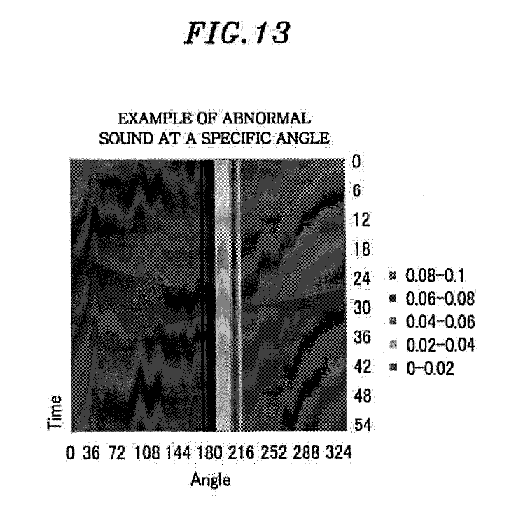

For example, when abnormal sounds occur at a position of about 180° to 216° as shown in FIG. 12, vertical lines are observed as shown in FIG. 13, and the characteristics thereof are detected from the deviation of the translation errors which is obtained by calculating mean and variance of the lines.

In the characteristics vectors, the temporal continuity on the horizontal direction in FIG. 11 is evaluated as continuity, and the angle dependency reproducibility on the vertical direction in FIG. 11 is evaluated by angle. Continuity is obtained by observing a variance of averages of the translation errors of twenty samples for three seconds. Angle is obtained by observing a variance of averages of the translation errors of twenty samples for one minute at an interval of 3 seconds.

A set of characteristic vectors in a normal state (normal sound) and that in an abnormal state (abnormal sound) which are obtained from the histograms are expressed as follows.

f(p1)=[average(p1), variance(p1), Kurtosis(p1), skewness(p1), continuity(p1), angle(p1)]

f(p2)=[average(p2), variance(p2), Kurtosis(p2), skewness(p2), continuity(p2), angle(p2)]

The histogram of the data to be detected can be compared with the normal sound model and the abnormal sound model by comparing the characteristic vectors. In this case, the number of sets of the characteristic vectors is calculated by dividing specified time of the abnormality detection by specified time of the probability distribution calculation. For example, if the specified time of the abnormality detection is about five minutes and the specified time of the probability distribution calculation is about one minute, the following five sets of characteristic vectors are generated for a single model (histogram).

Model1=[f1(p), f2(p), f3(p), f4(p), f5(p)]

The difference rate from the normal sound and the similarity rate to the abnormal sound can be obtained by employing the sets of characteristic vectors as initial values of training data and dividing them into two classes by using a support vector machine. The training data is defined as follows.

Determination for similarity rate to abnormal sound: abnormal model=1, normal model=−1

Determination for difference rate from the normal sound: normal model=1, abnormal model=−1

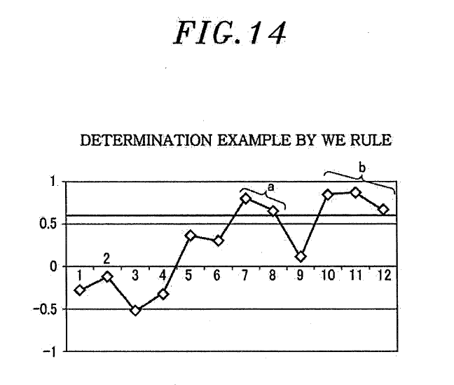

The difference rate and the similarity rate are not changed linearly, so that the changes thereof should be tracked by outputting estimated values using a regression coefficient of a support vector regression (SVR). When the conditions for abnormality determination are determined based on multiple operation experiences such as addition of abnormal patterns, optimization of threshold values, and the like, it is preferably to apply a Western Electric (WE) Rule. For example, in the case of a rule in which abnormality is determined when the threshold value is exceeded consecutive three times, the abnormality is not determined in an area a where the threshold value of 0.6 is exceeded consecutive two times, and the abnormality is determined in an area b where the threshold value is exceeded consecutive three times, as shown in FIG. 14. If high scores are consecutively detected in the same determination, it is determined that the state of the apparatus is changed and, thus, warning may be given.

The disturbance noise may also be determined by the support vector machine (SVM) under the conditions of the disturbance model=1 and the normal model=−1.

If it is determined in the abnormality determination that abnormality exists (Yes in step S9), the abnormality of the rotation driving system is displayed on the display unit (step S10). It may also be displayed on the printing unit 23. Meanwhile, if it is determined that abnormality does not exist (No in step S9), display of abnormality is not necessary. In that case, “No abnormality” may be displayed. The abnormality may be displayed in the form of warning such as flickering light or the like. In addition to such type of warning, warning sound such as buzzer or the like may also be provided.

In this manner, the existence or non-existence of abnormality of the rotation driving system may be detected by the abnormality detection apparatus 100 for the rotation driving system of the present embodiment. The abnormality detection apparatus 100 is movable and thus can diagnose a plurality of rotation driving systems.

The rotation driving system such as DRM or the like is rotated for a long period of time regardless of execution or non-execution of processes, so that sound can be sampled at a sufficient time interval. Thus, in the present embodiment, the abnormality determination is performed by calculating probability distribution of translation errors that are values representing determinism from the time series data in the predetermined time. Hence, even a small difference between the translational errors of the normal state and those of the abnormal state can be recognized as a big difference. Further, the difference between the normal state and the abnormal state can be recognized regardless of whether the translation error is deterministic or stochastic, so that the abnormality of the rotation driving system can be detected with high accuracy. Moreover, the abnormality determination is performed not based on instant probability distribution but based on probability distribution of a long period of time. Therefore, misjudgment caused by short-term disturbance noise or the like can be prevented. Further, the probability distribution is graphically expressed (histogram) and compared with the normal sound model and the abnormal sound model, so that the difference between the normal sound and the abnormal sound can be recognized with high precision from the characteristic vectors or the like. As a result, the abnormality of the rotation driving system can be detected with high precision.

As shown in FIG. 4, it is difficult to distinguish the normal sound and the abnormal sound in the time series data. Although peaks can be detected by frequency analysis using fast Fourier transformation (FET), it is difficult to quantitatively measure temporal changes of absolute values of the peaks or variance of the peak frequencies. In the present embodiment, the translation errors caused by changes of the absolute values or variance of the frequency are measured in terms of the probability. As a consequence, large-scale tuning is not required, which is very efficient.

Since the characteristics of the generated sound are evaluated in aspects of temporal continuity and rotation cycle dependency by using the information on the rotation cycle of the rotation driving system, the state in which the rotation sound of the rotation driving system is unstable is easily detected.

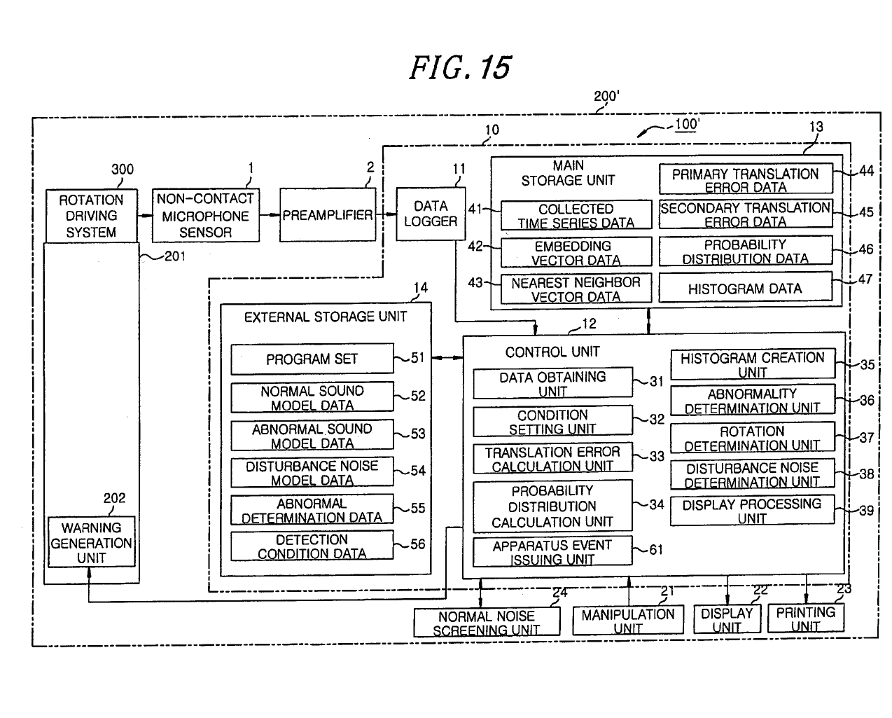

Although the abnormality detection apparatus 100 is movable in the above example, it may be of an assembly type as shown in FIG. 15. In the example shown in FIG. 15, an abnormality detection apparatus 100′ is installed in a processing apparatus 200′. In other words, the processing apparatus 200′ includes an apparatus main body 201, a rotation driving system 300, and the abnormality detection apparatus 100′.

The abnormality detection apparatus 100′ has substantially the same configuration as that of the abnormality detection apparatus 100 except in that the control unit 12 has an apparatus event issuing unit 61. Further, the apparatus main body 201 has a warning generation unit 202.

When the abnormality determination unit 36 detects abnormality of the rotation driving system, the apparatus event issuing unit 61 issues an apparatus event and outputs a warning generation signal to the warning generation unit 202 of the apparatus main body 201. The warning generation unit 202 instructs the apparatus maintenance by warning in accordance with a signal from the apparatus event issuing unit 61.

In the case of the assembly type, the rotation driving system can be monitored in real time and the apparatus event is issued to generate warning when abnormality is detected. Thus, sign of abnormality can be detected before critical abnormality such as a torque change occurs. As a result, grease up can be performed as planned.

The maintainability of the apparatus can be improved due to a function of performing an abnormality detection sequence at an appropriate interval and a function of storing elapsed time from previous grease up and a history of abnormality determination results.

### Second Embodiment

Hereinafter, a second embodiment of the present invention will be described.

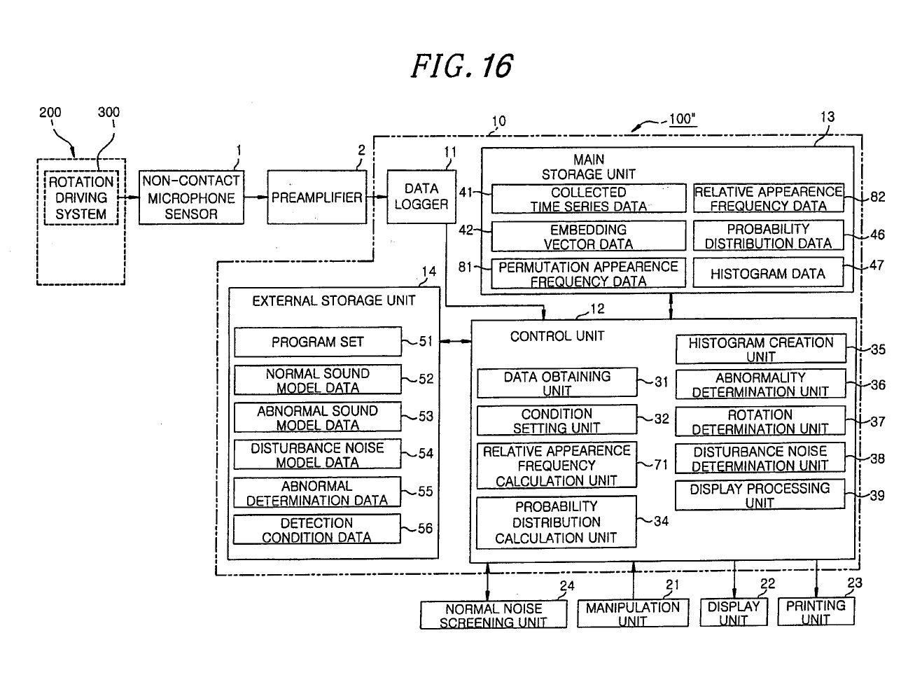

FIG. 16 is a block diagram showing an abnormality detection apparatus of a rotation driving system in accordance with the second embodiment of the present invention.

In the first embodiment, the translation error in the time series data is used as a value representing determinism. However, in the present embodiment, permutation entropy is used as a value representing determinism. The others are the same as those of the first embodiment. Thus, in FIG. 16, like reference numerals refer to like parts shown in FIG. 2, and description thereof will be omitted.

In the abnormality detection apparatus 100″ of the present embodiment, a control unit 12 performs time series signal processing on time series data (digital data) and converts it into a cyclic signal by the data logger 11. Then, probability distribution of relative appearance frequency m(π) corresponding to intermediate variation in the calculation process of the permutation entropy that is a value representing determinism which indicates whether the time series data is deterministic or stochastic is calculated from the time series data converted into the cyclic signal. Next, a histogram graphically expressing the probability distribution is created. By comparing the created histogram with a normal sound model (histogram) and one or more abnormal sound models (histograms), the existence or non-existence of the abnormality in the rotation driving system is determined.

The permutation entropy that has been introduced by Bandt and Pompe (C. Bandt and B. Pompe, Physical Review Letters, Vol. 88, pp. 174102-1-174102-4, 2002.) has an asymptotically equivalent amount to the Kolmogorov-Sinai entropy in infinitely long time series, but the permutation entropy is defined as follows.

The embedding vectors r(ti) in a certain dimension n are all generated from the time series data in the given time. For the embedding vectors, each the element of the embedding vectors has the numbering in ascending or descending order determined by the magnitude relation therebetween. The numbering arrangement in ascending or descending order is a permutation in the number of the elements. For all the embedding vectors in the given time, the number of the embedding vectors having the same ascending order or descending order is counted. The counted number is an appearance frequency of the permutation having that order. The appearance frequency with respect to the number of all the embedding vectors is referred to as a relative appearance frequency. The sum of the relative appearance frequencies is 1. The time difference Δt may be 1. In the case of Δt=1, the embedding vectors r (ti) are made up of the continuous n elements of the time series data.

The order determined by the magnitude relation of the elements of the embedding vectors is a permutation made up of the order of the number of the dimension of the embedding vectors. For the number n of embedding vectors, the set of n (from 1 to n) permutation is represented as Π, and the element of the set of the permutation (certain permutation) is represented as π. When the number of the time series data in the given time is represented as N, and the embedding dimension is represented as n, and the time difference is represented as Δt, the number of the embedding vectors generated from the time series data in the given time is represented as N−(n−1) Δt. When the appearance frequency of a certain permutation is represented as m (π), the relative appearance frequency p (π) of a certain permutation n is represented by the following formula (4):

$$p ( π ) = \frac{m ( π )}{N - ( n - 1 ) Δ t} \qquad ( 4 )$$

The relative appearance frequency p(π) is obtained by performing coarse gaining of the complexities of the time fluctuation and classifying them into patterns. The complexities of original time series (determinism) may be quantitatively assessed by regarding the relative appearance frequency p(π) as the appearance probability of the permutation π, and calculating the information entropy. A permutation entropy defined as the permutation n in the number of the dimension of the embedding vectors is to be a stochastic variable, and the relative appearance frequency p(π) is to be a stochastic distribution. The permutation entropy is defined by the following formula (5).

$$H ( n ) = - {\sum }_{π ∈ Π} p ( π ) {log}_{2} p ( π ) \qquad ( 5 )$$

However, the term of p(π)=0 is not included.

The permutation entropy may quantitatively assess the complexities (determinism) of original time series data. The simplest behavior is a monotonic process. The permutation entropy is minimum in the monotonic increasing process and the monotonic decreasing process. Meanwhile, the most complex behavior is a full random process. In this case, the permutation entropy will be the maximum, because all the possible patterns are realized.

π is a permutation of the embedding dimension n, and the permutation set H that includes the number n! of the elements (permutation), is represented by 0≦H(n)≦log₂ n!, based on the definition of the formula (5). The minimum corresponds to the monotonic increasing process or the monotonic decreasing process. The maximum represents the full random process.

Bandt and Pompe have focused that H (n) linearly increases against n to introduce a function that is defined by the following formula (6).

$$h ( n ) = \frac{H ( n )}{n - 1} \qquad ( 6 )$$

If h (n) is normalized by log₂ n!, the entropy defined by the following formula (7) may be used.

$${h}^{*} ( n ) = \frac{h ( n )}{{log}_{2} n !} \qquad ( 7 )$$

The formula 0≦h*(n)≦1 holds. As the deterministic aspect of the time series data increases, h*(n) will approach 0. If the time series data is a white noise, h*(n) will be proximal to 1. Thus, the permutation entropy H (n) or h*(n) that is obtained by normalizing H (n) becomes an indicator representing the determinism. Accordingly, in the present embodiment, the abnormality of the rotation driving system is detected by using the relative appearance frequency corresponding to the intermediate variation in the calculation process of the permutation entropy based on the fact that the permutation entropy H(n) or h*(n) that is obtained by normalizing H(n) becomes an indicator representing determinism of the time series data which indicates the state of the equipment to be diagnosed.

In the present embodiment, in order to realize such function, the control unit 12 has a relative appearance frequency calculation unit 71 for calculating the relative appearance frequency m(π), instead of the translation error calculation unit 33 of the first embodiment. The probability distribution calculation unit 34 calculates probability distribution of the relative appearance frequency m(π). The histogram creation unit 35 creates a histogram graphically expressing a frequency of a value of the appearance frequency m(π) based on the probability distribution data of the relative appearance frequency m(π).

The main storage unit 13 stores permutation appearance frequency data 81 instead of the nearest neighboring vector data 43, and also stores relative appearance frequency data instead of the primary and the secondary translation error data 44 and 45.

The relative appearance frequency calculation unit 71 generates embedding vectors, counts the permutation appearance frequency, and calculates the relative appearance frequency m(π).

The embedding vectors r(ti) are generated from the time series data. The dimension n of the embedding vectors and the time difference Δt are preset in accordance with the characteristics of the time series data. The set of the generated embedding vectors is stored as the embedding vector data 42 in the main storage unit 13.

The appearance frequency is calculated by numbering the elements of the embedding vectors in accordance with magnitude relation and counting, as the permutation appearance frequency, the number of embedding vectors having the same order in respect of all the embedding vectors in the predetermined time. The counted permutation appearance frequency is stored as the permutation appearance frequency data 81 at the main storage unit.

Then, the relative appearance number m(π) for the number of all the embedding vectors generated from the time series data in the predetermined time is calculated from the permutation appearance frequency data 81 and stored as the relative appearance frequency data 82 in the main storage unit 13.

Hereinafter, an abnormality detection operation of the abnormality detection apparatus for the rotation driving system in accordance with the second embodiment which has the aforementioned configuration will be described. The following operations are performed based on the instructions of the control unit 12.

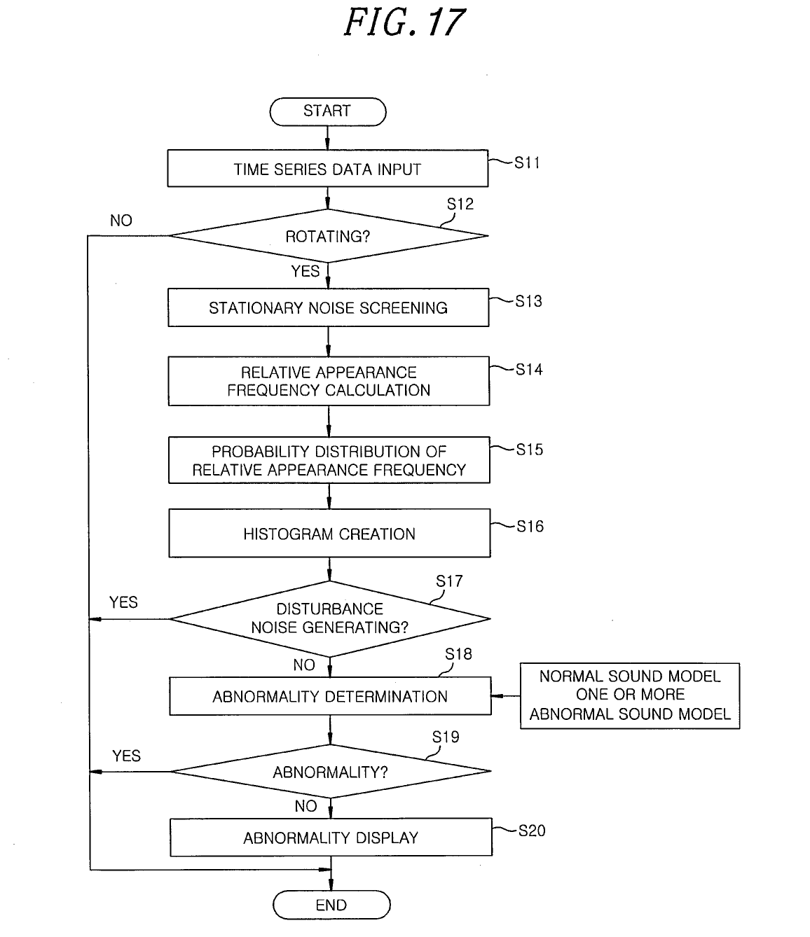

FIG. 17 is a flowchart showing an example of the abnormality detection operation for the rotation driving system in the second embodiment. A step S11 of inputting time series data to a step S13 of screening of stationary noise in the second embodiment corresponds to the steps S1 to S3 in the first embodiment.

Upon completion of the screening of stationary noise in the step S13, the relative appearance frequency is calculated from the time series data (step S14). Here, the relative appearance frequency calculation unit generates the embedding vectors, counts the permutation appearance frequency, and calculates the relative appearance frequency m(π).

Specifically, the embedding vectors r(ti) are generated from the collected time series data 41 by using the embedding dimension n and the time difference Δt which have been preset. Then, for each of the embedding vectors calculated from the time series data 41 in the predetermined time, the elements of the embedding vectors are numbered in accordance with magnitude relation, and the number of embedding vectors having the same order is counted as the permutation appearance frequency. Thereafter, the relative appearance frequency m(π) against the number of all the embedding vectors generated from the time series data in the predetermined time which is the intermediate variation in the calculation process of the permutation entropy is calculated from the permutation appearance frequency.

Next, the probability distribution of the relative appearance frequency m(π) is calculated by the probability distribution calculation unit 34 (step S15). The probability distribution is calculated by dividing the time series data of five minutes in the unit of one minute and using the relative appearance frequency m(π) in one minute. In the step S15, the translation error in the step S5 of the first embodiment is replaced by the relative appearance frequency that is the intermediate variation in the calculation process of the permutation entropy. Basically, the step S15 corresponds to the step S5.

Then, a histogram expressing a frequency of a value of the relative appearance frequency m(π) is created based on the probability distribution data by the histogram creation unit 35 (step S16).

Thereafter, the disturbance noise determining unit 38 determines existence or non-existence of the disturbance noise by comparing the created histogram with the histogram of the disturbance noise model and one or more disturbance noise model data 54 (step S17). This step corresponds to the step S7 in the first embodiment.

When it is determined that the disturbance noise does not exist, the abnormality determination unit 36 determines whether or not a detection target has abnormality (step S18).

The abnormality determination is carried out by comparing the histogram data created from the probability distribution of the relative appearance frequency m(π) of the time series data to be detected with the normal sound model data 52 and one or more abnormal sound model data 53 which have been previously stored in the external storage unit 14. In this embodiment, the normal sound model data 52 is histogram data created from the relative appearance frequency m(π) of the time series data of the normal sound model, and the abnormal sound model data 53 is histogram data created from the relative appearance frequency m(π) of the time series data of the one or more abnormal sound models. By comparing the histogram of the data to be detected with the histogram of the normal sound model, a difference rate from the normal sound model is calculated. Further, by comparing the histogram of the data to be detected with the histogram of the one or more abnormal sound models, a similarity rate to the abnormal sound model is calculated. Accordingly, the existence or non-existence of the abnormality is determined. These processes are performed as in the first embodiment.

If it is determined in the abnormality determination that the abnormality exists (Yes in step S19), the abnormality of the rotation driving system is displayed by the display unit 22 (step S20). Further, it may be printed by the printing unit 23. Meanwhile, if it is determined that the abnormality does not exist (No in step S19), display of abnormality is not necessary. In that case, “No abnormality” may be displayed. The abnormality may be displayed in the form of warning such as flickering light or the like. In addition to such type of warning, warning sound such as buzzer or the like may also be provided.

In the present embodiment as well, the probability distribution of the relative appearance frequency corresponding to the intermediate variation in the calculation process of the permutation entropy that is a value representing determinism is calculated from the time series data in the predetermined time, and the existence or non-existence of abnormality is determined based thereon. Therefore, even a small difference between the relative appearance frequency in the normal state and that in the abnormal state may be recognized as a large difference. Accordingly, the abnormality of the rotation driving system can be detected with high precision.

Further, the abnormality determination is performed not based on instant probability distribution but based on probability distribution of a long period of time. Thus, misjudgment caused by short-term disturbance noise or the like can be prevented. Moreover, the probability distribution is graphically expressed (histogram) and compared with the normal sound model and the abnormal sound model, so that the difference between the normal sound and the abnormal sound can be recognized with high precision from the characteristic vectors or the like. As a result, the abnormality of the rotation driving system can be detected with high precision.

<The Other Application>

The present invention may be variously modified without being limited to the above embodiments. For example, although there have been described the cases of using the rotation driving system as an example of the periodic driving system in the above described embodiments, in view of principle of the present invention, the periodic driving system may be a linear driving system, a vibration system, a compression and expansion driving system or the like without being limited to the rotation driving system.

Specifically, as the periodic driving system, there are a transfer arm for transferring a substrate such as a semiconductor wafer; an elevation pin for moving up and down a substrate; an elevation mechanism for moving up and down a stage for a substrate; and so forth. In general, as the periodic driving system, there are a piston of an engine; a sewing machine, a machine tool such as a jigsaw, and so forth.

Further, in the above embodiments, the translation error and the permutation entropy are described as values representing determinism. However, the values representing determinism are not limited thereto. Further, although the probability distribution of the values representing determinism is expressed by a histogram (graphically expressed), it may be expressed by a graph rather than a histogram or may not be graphically expressed. Moreover, although the example in which the abnormality of the periodic driving system is determined by using the difference rate from the normal sound model and the similarity rate to the abnormal sound model is described, the abnormality may be determined by using one of the difference rate and the similarity rate.

The abnormality detection apparatus for the periodic driving system of the present invention can be realized by a normal computer system, not by a special system. For example, the abnormality detection apparatus for the periodic driving system of the present invention may be configured by storing in a computer-readable recording memory (flexible disc, CD-ROM, DVD-ROM, or the like) a computer program for executing the operation and by installing the computer program into a computer. Moreover, the abnormality detection apparatus for the rotation driving system of the present invention may be configured by storing the computer program in a storage unit provided in a server device on a communication network such as the Internet or the like and downloading the computer program by, e.g., a general computer system.

When the functions of the abnormality detection apparatus are realized by sharing application programs with an OS (operating system) or by cooperating application programs with an OS, only the application programs may be stored in a storage medium or a storage device.

Additionally, the computer program may be superposed on a carrier and distributed via a communication network. Further, it may be configured to execute such process by running the distributed computer program.

While the invention has been shown and described with respect to the embodiments, it will be understood by those skilled in the art that various changes and modification may be made without departing from the scope of the invention as defined in the following claims.

What is claimed is:

1. An abnormality detection apparatus for a periodic driving system which is used for an operation of a processing apparatus, comprising:
a detection unit configured to detect sound from the periodic driving system;
a data obtaining unit for time series data that temporally varies from the detected sound;
a determinism derivation unit configured to derive a plurality of values representing determinism providing an indicator of whether the time series data is deterministic or stochastic or a plurality of intermediate variations in a calculation process of the values representing determinism at a predetermined interval from the time series data that have been obtained by the data obtaining unit;
a probability distribution calculation unit configured to calculate probability distribution of the values representing determinism or the intermediate variations; and
a determination unit configured to determine existence or non-existence of abnormality in the periodic driving system based on the probability distribution of the values representing determinism or the intermediate variations.

2. The abnormality detection apparatus of claim 1, further comprising: a graphic information creation unit configured to create graphic information from the probability distribution calculated by the probability distribution calculation unit,
wherein the determination unit determines existence or non-existence of abnormality in the periodic driving system by comparing the graphic information generated from the probability distribution with normal sound graphic information created from the probability distribution of values representing determinism of a normal sound model or intermediate variations in the calculation process of the values thereof which have been previously obtained and/or one or more abnormal sound graphic information created from the probability distribution of values representing determinism of an abnormal sound model or intermediate variations in the calculation process of the values thereof which have been previously obtained, and then obtaining a difference rate of the graphic information from the normal sound model graphic information and/or a similarity rate of the graphic information to the abnormal sound graphic information.

3. The abnormality detection apparatus of claim 2, wherein the graphic information, the normal sound graphic information, and the abnormal sound graphic information are histograms created from the probability distribution of the values representing determinism.

4. The abnormality detection apparatus of claim 3, wherein the determination unit calculates the difference rate from the normal sound graphic information and/or the similarity rate to the abnormal sound graphic information by comparing the histogram of the graphic information with the histogram of the normal sound graphic information and/or the histogram of the abnormal sound graphic information in aspects of four characteristic vectors including average, variance, kurtosis and skewness.

5. The abnormality detection apparatus of claim 4, wherein the determination unit further uses, as the characteristic vectors for comparing the histogram of the graphic information with the histogram of the normal sound graphic information and/or the histogram of the abnormal sound graphic information, temporal continuity and periodic dependency of sound.

6. The abnormality detection apparatus of claim 4, wherein the difference rate from the normal sound graphic information and the similarity rate to the abnormal sound graphic information is obtained by employing the characteristic vectors as initial values of training data and dividing the characteristic vectors into two classes by using a support vector machine, existence or non-existence of abnormality being determined based on whether or not a value thus obtained exceeds a predetermined threshold value.

7. The abnormality detection apparatus of claim 1, wherein the values representing determinism are translation errors calculated from the time series data; and
the determinism derivation unit includes:
an embedding unit configured to divide the time series data into a plurality of parts at a predetermined time interval and calculating embedding vectors of arbitrary dimensions therefrom;
a nearest neighboring vector extraction unit configured to extract a predetermined number of nearest neighboring vectors from a certain embedding vector among the embedding vectors calculated by the embedding unit for each of the time series data divided at the predetermined time interval; and
a translation error calculation unit configured to calculate translation errors of the predetermined number of nearest neighboring vectors extracted by the nearest neighboring vector extraction unit for each of the time series data divided at the predetermined time interval.

8. The abnormality detection apparatus of claim 1, wherein the values representing determinism are permutation entropies calculated from the time series data; and
the determinism derivation unit includes:
an embedding unit configured to dividing the time series data into multiple parts at a predetermined time interval and calculating embedding vectors of arbitrary dimensions therefrom; and
a relative appearance frequency calculation unit configured to number the elements of the embedding vectors calculated from the time series data in the predetermined time in accordance with magnitude relation for each of the time series data divided at a predetermined time interval, count the number of embedding vectors having the same order as the permutation appearance frequency, and calculating the relative appearance frequency against the number of all the embedding vectors generated from the time series data in the predetermined time which is the intermediate variation in the calculation process of the permutation entropy,
wherein the probability distribution calculation unit calculates probability distribution of the relative appearance frequency.

9. The abnormality detection apparatus of claim 1, further comprising a display unit that displays abnormality when the abnormality is determined by the determination unit.

10. The abnormality detection apparatus of claim 1, wherein the periodic driving system is a rotation driving system, a linear driving system, a vibration system, or a compression and expansion driving system.

11. A processing apparatus comprising a processing apparatus main body for performing a predetermined processing, a periodic driving system used for processing of the processing apparatus main body, and an abnormality detection apparatus configured to detect abnormality of the periodic driving system, wherein the abnormality detection apparatus includes:
a detection unit configured to detect sound from the periodic driving system;
a data obtaining unit configured to obtain time series data that varies temporally from the detected sound,
a determinism derivation unit configured to derive a plurality of values representing determinism providing an indicator of whether the time series data is deterministic or stochastic or a plurality of intermediate variations in a calculation process of the values representing determinism at a predetermined interval from the time series data that have been obtained by the data obtaining unit;
a probability distribution calculation unit configured to calculate probability distribution of the values representing determinism or the intermediate variations; and
a determination unit configured to determine existence or non-existence of abnormality in the periodic driving system based on the probability distribution of the values representing determinism or the intermediate variations.

12. The processing apparatus of claim 11, further comprising: a graphic information creation unit configured to create graphic information from the probability distribution calculated by the probability distribution calculation unit,
wherein the determination unit determines existence or non-existence of abnormality in the periodic driving system by comparing the graphic information generated from the probability distribution with normal sound graphic information created from the probability distribution of values representing determinism of a normal sound model or intermediate variations in the calculation process of the values thereof which have been previously obtained and/or one or more abnormal sound graphic information created from the probability distribution of values representing determinism of an abnormal sound model or intermediate variations in the calculation process of the values thereof which have been previously obtained, and then obtaining a difference rate of the graphic information from the normal sound model graphic information and/or a similarity rate of the graphic information to the abnormal sound graphic information.

13. The processing apparatus of claim 12, wherein the graphic information, the normal sound graphic information, and the abnormal sound graphic information are histograms created from the probability distribution of the values representing determinism.

14. The processing apparatus of claim 13, wherein the determination unit calculates the difference rate from the normal sound graphic information and/or the similarity rate to the abnormal sound graphic information by comparing the histogram of the graphic information with the histogram of the normal sound graphic information and/or the histogram of the abnormal sound graphic information in aspects of four characteristic vectors including average, variance, kurtosis and skewness.

15. The processing apparatus of claim 14, wherein the determination unit further uses, as the characteristic vectors for comparing the histogram of the graphic information with the histogram of the normal sound graphic information and/or the histogram of the abnormal sound graphic information, temporal continuity and periodic dependency of sound.

16. The processing apparatus of claim 14, wherein the difference rate from the normal sound graphic information and the similarity rate to the abnormal sound graphic information is obtained by employing the characteristic vectors as initial values of training data and dividing the characteristic vectors into two classes by using a support vector machine, existence or non-existence of abnormality being determined based on whether or not a value thus obtained exceeds a predetermined threshold value.

17. The processing apparatus of claim 11, wherein the values representing determinism are translation errors calculated from the time series data; and
the determinism derivation unit includes:
an embedding unit configured to divide the time series data into a plurality of parts at a predetermined time interval and calculating embedding vectors of arbitrary dimensions therefrom;
a nearest neighboring vector extraction unit configured to extract a predetermined number of nearest neighboring vectors from a certain embedding vector among the embedding vectors calculated by the embedding unit for each of the time series data divided at the predetermined time interval; and
a translation error calculation unit configured to calculate translation errors of the predetermined number of nearest neighboring vectors extracted by the nearest neighboring vector extraction unit for each of the time series data divided at the predetermined time interval.

18. The processing apparatus of claim 11, wherein the values representing determinism are permutation entropy calculated from the time series data; and
the determinism derivation unit includes:
an embedding unit configured to divide the time series data into multiple parts at a predetermined time interval and calculating embedding vectors of random dimensions therefrom; and
a relative appearance frequency calculation unit configured to number the elements of all the embedding vectors calculated from the time series data in the predetermined time in accordance with magnitude relation for each of the time series data divided at a predetermined time interval, counting the number of embedding vectors having the same order as the permutation appearance frequency, and calculating the relative appearance frequency against the number of all the embedding vectors generated from the time series data in the predetermined time which is the intermediate variation in the calculation process of the permutation entropy from the permutation appearance frequency,
wherein the probability distribution calculation unit calculates probability distribution of the relative appearance frequency.

19. The processing apparatus of claim 11, wherein the abnormality detection apparatus further includes an apparatus event issuing unit configured to provide warning by issuing an apparatus event to the processing apparatus body when the abnormality of the periodic driving system is determined by the determination unit.

20. The processing apparatus of claim 11, wherein the periodic driving system is a rotation driving system, a linear driving system, a vibration system, or a compression and expansion driving system.

21. A method for detecting abnormality of a periodic driving system used for processing of a processing apparatus, comprising:
obtaining time series data that varies temporally from sound detected from the periodic driving system;
calculating a plurality of values representing determinism which indicates whether the time series data is deterministic or probabilistic or a plurality of intermediate variations in the calculation process of the values representing determinism at a predetermined time interval from the time series data obtained in the data obtaining step;
calculating probability distribution of the values representing determinism or the intermediate variations; and
determining existence or non-existence of abnormality in the periodic driving system based on the probability distribution of the values representing determinism or the intermediate variations.

22. The method of claim 21, further comprising: creating graphic information from the probability distribution calculated from the probability distribution calculation step,
wherein in the determination step, existence or non-existence of abnormality in the periodic driving system is determined by comparing the graphic information generated from the probability distribution with normal sound graphic information created from the probability distribution of values representing determinism of a normal sound model or intermediate variations in the calculation process of the values thereof which have been previously obtained and/or one or more abnormal sound graphic information created from the probability distribution of values representing determinism of an abnormal sound model or intermediate variations in the calculation process of the values thereof which have been previously obtained, and then obtaining a difference rate of the graphic information from the normal sound model graphic information and/or a similarity rate of the graphic information to the abnormal sound graphic information.

23. The method of claim 22, wherein the graphic information, the normal sound graphic information and the abnormal sound graphic information are given as histograms created from the probability distribution of the values representing determinism.

24. The method of claim 23, wherein in the determination step, the difference rate from the normal sound graphic information and/or the similarity rate to the abnormal sound graphic information are obtained by comparing the histogram of the graphic information with the histogram of the normal sound graphic information and/or the histogram of the abnormal sound graphic information in aspects of four characteristic vectors including average, variance, kurtosis and skewness.

25. The method of claim 24, wherein in the determination step, temporal continuity and periodic dependency of sound are further used as the characteristic vectors for comparing the histogram of the graphic information with the histogram of the normal sound graphic information and/or the histogram of the abnormal sound graphic information.

26. The method of claim 24, wherein the difference rate from the normal sound graphic information and the similarity rate to the abnormal sound graphic information is obtained by employing the characteristic vectors as initial values of training data and dividing the characteristic vectors into two classes by using a support vector machine, existence or non-existence of abnormality being determined based on whether or not a value thus obtained exceeds a predetermined threshold value.

27. The method of claim 21, wherein the values representing determinism are translation errors calculated from the time series data; and
the determinism derivation step includes:
dividing the time series data into a plurality of parts at a predetermined time interval and calculating embedding vectors of arbitrary dimensions therefrom;
extracting respectively predetermined numbers of nearest neighboring vectors from a certain embedding vector among the embedding vectors calculated by the embedding unit for each of the time series data divided at the predetermined time interval; and
calculating translation errors of the predetermined number of nearest neighboring vectors extracted by the nearest neighboring vector extraction unit for each of the time series data divided at the predetermined time interval.

28. The method of claim 1, wherein the values representing determinism are permutation entropies calculated from the time series data;
the determinism derivation step includes:
dividing the time series data into multiple parts at a predetermined time interval and calculating embedding vectors of arbitrary dimensions therefrom; and
numbering the elements of the embedding vectors calculated from the time series data in the predetermined time in accordance with magnitude relation for each of the time series data divided at a predetermined time interval, counting the number of embedding vectors having the same order as the permutation appearance frequency, and calculating the relative appearance frequency against the number of all the embedding vectors generated from the time series data in the predetermined time which is the intermediate variation in the calculation process of the permutation entropy,
wherein in the probability distribution calculation step, the probability distribution of the relative appearance frequency is calculated.

29. The method of claim 21, further comprising displaying abnormality when the abnormality is determined by the determination unit.

30. The method of claim 21, wherein the periodic driving system is a rotation driving system, a linear driving system, a vibration system, or a compression and expansion driving system.

31. A computer program for causing a computer to perform the method described in claim 21.
